(19) United States
(12) Patent Application Publication
(10) Pub. No.: US 2015/0134321 A1
(43) Pub. Date: May 14, 2015

(54) SYSTEM AND METHOD FOR TRANSLATING TEXT

(71) Applicant: Thomas Fennell, Omaha, NE (US)

(72) Inventor: Thomas Fennell, Omaha, NE (US)

(73) Assignee: Thomas Fennell, Omaha, NE (US)

(21) Appl. No.: 14/535,633

(22) Filed: Nov. 7, 2014

Related U.S. Application Data
(60) Provisional application No. 61/901,855, filed on Nov. 8, 2013.

(51) Int. Cl. G06F 17/28

(52) U.S. Cl. CPC G06F 17/28
USPC 704/2

(57) ABSTRACT

The present invention discloses a system and method for assisting the translation of texts through forming, displaying and interacting with translation units. According to a preferred embodiment, a system is provided in which a text presentation and input structure is provided which includes a multi-dimensional matrix. In one embodiment, it allows different levels of chunking to be displayed using a drill-down/zoom-type function. The plurality of chunks is separated vertically with sub-chunks divided in the horizontal and with a depth dimension.

### RELATED APPLICATIONS

The present application claims priority to U.S. Provisional Application No. 61/901,855 filed Nov. 8, 2013.

### FIELD OF INVENTION

1. Technical Field of the Disclosure

The present invention is related in general to the field of language translation, and in particular, to a system and method for assisting the translation of texts through forming, displaying and interacting with translation units.

2. Background of the Invention

The complexity and variety of human language has meant that machine translation (MT) has achieved only limited success. Likewise, translation memory (TM) software, which utilizes databases of aligned source and target texts to increase the productivity of human translators, has proven itself to be of real, but limited value. TM has now evolved into being the central component of Translation Environment (TEnT) systems to increase human translator productivity and they typically include a number of components such as translation memories, termbases and lexicons.

In operation, translation programs often break text down into grammatically independent segments delimited by various formal criteria. Additionally, machine translation uses syntactic hierarchies. Using these tools, conventional translation programs apply logical rules to create constituent groups of words. These groups of words are understood to be logically embedding inside one another to form larger constituents. The syntactic hierarchy (from smaller to larger units) is generally understood to include: morphemes; words, phrases, sentences (clauses) and text. The nesting of these units inside higher levels occurs in an asymmetric fashion, producing a very wide variety of elaborate hierarchical structures, producing descriptions which are very difficult for both human translators to utilize; machine translation programs also struggle to utilize them.

TM systems store aligned source-target segments automatically, and technically savvy translators currently use translation memories, termbases and lexicons to store aligned bi-text portions smaller than a segment which they sense may be useful. However, initiation of the sub-segment alignment process relies upon incomplete human memory of minute textual detail, sporadic semantic recognition and intuition. Furthermore, the ability to fully leverage text is substantially limited by the infrequent occurrence of matches and near-matches with segments, and the difficulties of sub-segment alignment.

In addition, the current state of the art is based on a linear presentation of segment text which primarily utilizes old input mechanisms (e.g., screen, keyboard, and mouse). The structure of large segments can differ greatly between source and target, and analyzing, processing and reviewing such segments requires great, repetitive mental effort on the part of a translator. The opportunities afforded by new input mechanisms (e.g., touch, voice) have only been implemented within the technologies designed for keyboard and mouse. TEnT programs have not been redesigned to fully take advantage of the capabilities of the new input devices.

In a known prior art related to the language translation systems, a chunking utility is provided to group text segments which are not marked by formal markers into chunks which can be roughly aligned to words and phrases in the target language. However, these inventions deal mainly with ideographic languages (e.g., Chinese and Japanese kanji script) and those with syllabic representation (e.g., Japanese hiragana and katakana), and they are primarily concerned with ambiguity in the proper boundaries between words.

Further advancements in the art include systems which use a chunking technique to guide parsing. These systems use a recursive application of syntactic parsing rules to create a parsing tree. To decrease complexity, it breaks the sentence down into chunks for the application of parsing rules to avoid the exponentially increasing complexity of trying to parse a whole sentence. However, the downside to this system is that the chunks formed are accurate based on syntax rules and syntactic hierarchies which are meant for further machine translation. This parsing method is not intended for and has very limited utility for assisting human translation.

Based on the foregoing there is a need for a system and method for breaking down segments into units better suited for human translation which will: 1) significantly improve leverage of aligned translations in comparison to segment-based text pairs; and 2) utilize the capabilities provided by new input devices to increase the productivity of the translation process. Such a needed system and method would make it much easier for a translator to structure and sequence the mental processes required when formulating, inputting and reviewing translations, alleviating the mental processing burden and increasing translation productivity. There is also a serious need for the human-reviewed alignment of smaller source-target portions in order to provide better data for machine translation.

### SUMMARY OF THE DISCLOSURE

To minimize the limitations found in the prior art, and to minimize other limitations that will be apparent upon reading of the specification, a preferred embodiment of the present invention provides a system and method for chunking, manipulating, aligning and conducting mass analysis of texts and aligned text portions.

Complex sentences are artificial constructions which must be thoroughly deconstructed for translation. This thorough deconstruction requires substantial and very recursive mental effort. The mind thinks naturally in groups of words similar to spoken utterances, not in complex sentences. The system and method of the present invention discloses that texts can be structured into a plurality of chunks which: 1) approximate spoken human utterances; 2) better accommodate human thought processes; and 3) are optimized for translation activity using a variety of criteria to divide the text into the plurality of chunks. Such chunks must be neither too small (as with full syntax parsing), nor too large (as with segmentation by formal markers). Rather, an optimum length is sought which combines semantic equivalence and syntactic cohesion (as with segments) with accommodation of human thought processes (utterance-length) and maximum leverage. Some key chunks (such as verbs, conjunctions) may have a very short optimum visual display length, 0-4 words (0 for items such as implied verbs), but most will be utterance-length, usually 4-12 words with an upper boundary of 4-16 words. Such length-limited chunking makes texts easier to comprehend and manipulate, reducing complexity and enabling increased leverage of the aligned text portions, which than formation of TM portions based on segments.

According to a first preferred embodiment of the present invention, chunks are formed using a variety of criteria, which can be used in various combinations depending on the relationship between the segment to be translated and the resources (e.g., Translation Memory (TM), repetitive sets) available. The most minimal embodiment of the invention would be to simply divide segments into chunks with a certain number of words, or a combination of words and punctuation. Adding in syntactic parsing techniques from the prior art would improve the result further. Still, the best results are to be obtained in a preferred embodiment, which first applies translation memory portion matches (if available), then stored repetitive sets from the source text, corpora or very large corpora (if available) are matched, and then if necessary, a combination of the other criteria listed above: length, punctuation, syntax parsing may be applied. In this process, a stored repetitive set should be understood to be a string of text which repeats itself one or more times within a source document or corpus of source documents.

In accordance with one embodiment of the present invention, the plurality of chunks will be further structured into chunks groups and/or sub-chunks (chunking elements). Chunk groups are of several types: 1) syntactically cohesive sets of source text chunks which are highly likely to retain syntactic cohesion in the target text; 2) continuous or non-contiguous sets of source text chunks which should be treated as a group to preserve the structure of their chunking; and 3) sub-chunking of selected chunks to facilitate provision of reference material, construction of word-pairing specific micro-rules, and alignment down to the minimal semantic alignment units for any given text. Minimum alignment units have great utility for quality control, especially omission checks, as well as serving as improved source data for machine translation. It has previously not been considered feasible to mark and confirm them, but optimal embodiments of the present invention enable such functionality. Preferably, chunks are also divided into sub-chunks in order to provide for automated placement of token elements (e.g., punctuation, numbers, dates, termbase and small translation memory (TM) text portion matches, small repetitive word sets and machine translated text) which are to be inserted automatically in order to provide a containing space for tokens to be inserted manually and to allow facilitated manipulation of selected elements.

In accordance with an exemplary embodiment of the present invention, various chunking criteria are employed to maximize the number of text groups likely to retain syntactic cohesion in the target text, while avoiding a confusing proliferation of low-level syntax hierarchy units, keeping many or most chunks around the size of a human utterance. Accordingly, two chunks can be aligned as semantic equivalents. Word order within chunks may differ, but each of the chunks can be aligned in the present system and method. Significant differences in syntax may exist within a segment.

In this embodiment, the system and method provides a user with an automated and dynamic interface through which a user may manipulate and restructure segments and sub-segments in order to achieve the source-target alignment of chunks, and optionally sub-chunks and discrete semantic elements. One criterion which is used in some embodiments of the invention is the criterion of translation memory text portions. The system and method may use of any available translation memory text portions which match the text in a given segment to provide for alignment between the source and target text. The system and method may also be configured to not provide alignment if the target translation changes due to a shift in context or by decision of a translator. Once alignment has been provided, the remaining segment text is then chunked after accounting for the translation memory text portion chunk(s).

Another criterion to apply is that of matching with token sets which repeat within a document, a corpora, a very large corpora, or any subset of these. Non-limiting examples of token sets comprise words and other symbols such as punctuation, numbers, etc. Word sets may be saved both with other tokens and without them, or in multiple versions to enhance leverage. This criterion may be used alone, or in combination with other chunking criteria. They may be referred to herein as “repetitive sets.”

Preferably, the present system and method provides systematic use of repetitive source words and/or token sets to mark text for chunking in order to further generate aligned translation pairs. The use of repetitive token sets may be utilized in early processing and interaction with an implementation of the invention.

In accordance with yet another exemplary embodiment of the present invention, a text presentation and input structure is provided which is a multi-dimensional matrix. In one embodiment, it allows different levels of chunking to be displayed using a drill-down/zoom-type function. In this embodiment, the plurality of chunks is separated vertically with sub-chunks divided in the horizontal and with a depth dimension in the drill-down/zoom embodiment. Using legacy standard input devices (e.g., keyboard and mouse), the system provides rapid sub-chunk selection for a user interacting with the system and manipulation functionality through both menu-driven commands and a hotkey command structure (e.g., Alt+3 for “select chunk 3”) to select and manipulate chunked elements. Manipulation using more advanced current input devices (touch screen and voice input) provide even greater utility and ease.

This information structure of the present system assists in the sequencing of the mental processes required when formulating, inputting and reviewing translations, alleviating the mental processing burden inherent in the linear, segment-based presentation structure.

In accordance with still another exemplary embodiment of the present invention, comprehensive alignment of all chunking elements in the target text, down to the most granular alignment level possible is achieved either manually or by cycling through a series of alignment options provided by the system. Heretofore, machine translation has relied upon fragmentary and error-prone automated statistical analysis of word set pairings. The present invention is distinguished in providing generation of much more reliable human-validated data. Further, exemplary versions of the invention provides use of collaborative organizational models to analyze and classify words, word sets and word as well as word set pairings and the generation of rules.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and to improve the understanding of the various elements and embodiments of the invention. Furthermore, elements that are known to be common and well understood to those in the industry are not depicted in order to provide a clear view of the various embodiments of the invention. Thus, it should be understood that the drawings are generalized in form in the interest of clarity and conciseness.

FIG. 1 is a flow chart illustrating a system and method for translation of a text segment in accordance with a preferred embodiment of the present invention.

FIG. 1A is a continuation of a flow chart illustrating a system and method for translation of a text segment in accordance with a preferred embodiment of the present invention.

FIGS. 2A-2C illustrate an example of several criteria being employed to chunk a text segment.

FIGS. 3A-3B illustrate an example of grouping of chunks in a text segment after applying chunking criteria.

FIG. 4 illustrates a block diagram of a language translation system in accordance with a preferred embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Further, various inventive features are described below that can each be used independently of one another or in combination with other features. However, any single inventive feature may not address any of the problems discussed above or only address one of the problems discussed above. Additionally, one or more of the problems discussed above may not be fully addressed by any of the features described below.

At least portions of the functionalities or processes described herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of complied C++, Java, HTML, or any other programming or scripting code such as R, Python and/or Excel. Additionally, the functions of the disclosed embodiments may be implemented on one computer or shared/distributed among two or more computers in or across a network.

The present invention discloses a method and system for assisting human translation of texts by using chunking. Segments, which are usually full sentences, are often far too complex to be translated immediately. A translator must break it down into its constituent parts and recompile the segments in the target language. This normally entails retaining the overall structure and the many corresponding components in short-term memory human memory. The present invention discloses a computer-implemented system for automatically structuring text for translation. This structuring makes it more similar in structure and complexity to the most natural basic unit of language, spoken human utterances, generally taken to be in the range of from 4-12 morphemes for adults with normal development (roughly 4-10 words). In order to be translated, each element of a text and its function in a sentence needs to be understood with high precision. A sentence is an artificial construct (or its formally divided sub-units and sub-segments) which can be absorbed more readily and translated with less mental strain when divided up into units which approximate the units with which humans generate speech (utterances).

There are many advantages for structuring text into utterance-length chunks. Firstly, it is a more efficient unit for human mental process and physical input by voice. If the chunks are smaller, speech recognition becomes less accurate and the speed advantages of voice input are reduced. If chunks are longer, they become harder to retain as a unit in human memory, and harder to speak out in a single utterance due to natural restrictions on speech and breathing. Secondly, manipulating text by any input device usually becomes much more efficient at the chunk level. Thirdly, utterances are also roughly parallel to the optimal size of units which reliably retain semantic stability and syntactic cohesion between source and target. Word sets smaller than 4-5 words can be too ambiguous and syntactic cohesion between source and target too unreliable for useful leveraging. As units increase beyond the size of an utterances, the frequency of their occurrence within a document or corpus usually rapidly decreases, thus they are less available for leveraging. There is no absolute size for a chunk. Some single words like conjunctions can be remarkably stable between languages, and they can be directly configured by a user as chunks, but the optimum size for chunking in an utterance sized unit.

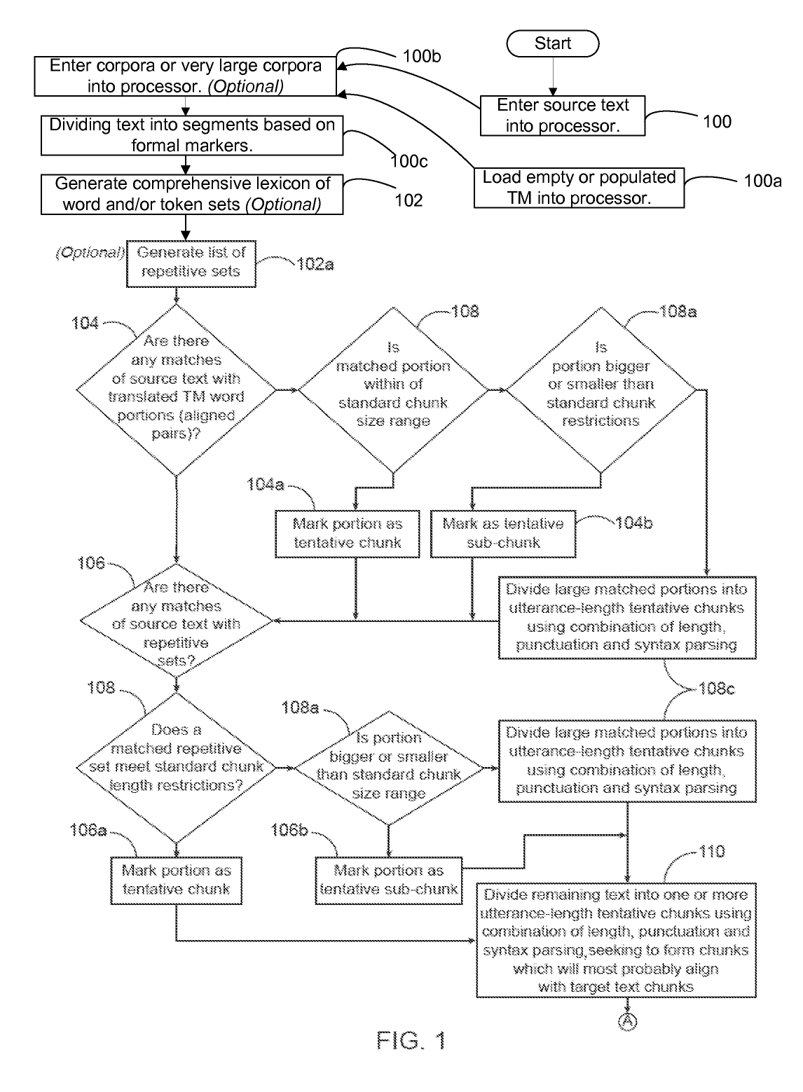

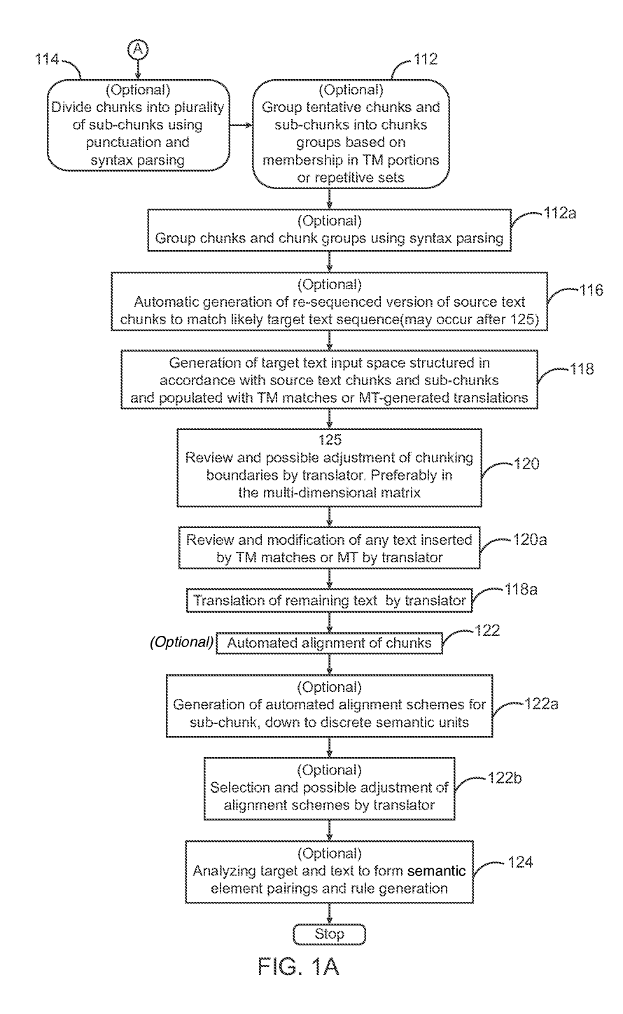

FIGS. 1 and 1A provide a flow chart illustrating a system and method for translation of a text segment in accordance with a preferred embodiment of the present invention. As shown, the system and method for translation of the text segment includes the step of entering a source text segment in a processor for translation as shown at block 100. This may be initiated by a translator or may be otherwise automatically triggered or generated by an automated electronic source. One or more empty translation memory (TM) databases and/or one or more translation memory databases comprising a plurality of translation memory text segments and portions is provided by the processor 100a. Further, in a preferred embodiment, a larger corpora of source words is provided 100b, in order to generate a list of sets of words, or words and other tokens, which are repeated in the source text within a document, corpora or very large corpora (repetitive sets). This lexicon is shown at blocks 102 and 102a. It is first checked whether any text in a segment matches a translation memory word portion as shown at block 104. If yes, then these are designated as tentative chunk candidate boundaries as shown at blocks 104a and 104b. Then it is checked whether there are any matches between the segment text and the repetitive sets as shown at block 106. If yes, then these are overlaid onto the source and designated as a tentative chunking boundary as shown at blocks 106a and 106b. Although repetitive set boundaries may overlap with translation memory portion chunks, it is most useful to retain the overlapping boundary in order to maintain the part of the repetitive set filled in by the translation memory. It is also preferable to retain the entire repetitive set for further use as a distinct translation memory portion after translation. For repetitive sets which overlap with translation memory portions, a chunking alignment point or break point may be automatically inserted in the translation memory portion match source text and the translator may optionally insert a chunking alignment or break point in the target text.

If the tentative chunk boundaries provided by translation memory portion and repetitive set matching along with the unchunked sections are larger than the maximum preferred chunk size as shown at blocks 108 and 108a, then the boundaries are readjusted using the chunking break points, then using formal markers (punctuation) and/or syntax parsing methods from the prior art as shown at block 108c. The former tentative chunks are to be marked as chunk groups. The remaining unchunked text is then automatically divided by the system into chunks, preferably chunks which will have a probability of being equivalent to syntactically cohesive aligned target chunks. (Such probable alignment of chunks may hereinafter be referred to as syntactic cohesion). This system and method and the chunking criteria applied aim to maximize such probable alignment. These chunks will, usually be utterance-sized, using formal markers (punctuation) and/or syntax parsing methods from the prior art as shown at block 110. In some embodiments, syntax parsing (including syntactic hierarchies) may then be used to group chunks together into one or more levels of chunk groups with probable syntactic cohesion between source and target as shown at blocks 112 and 112a.

In some embodiments, the plurality of chunks is further subdivided into a plurality of sub-chunks with a processor using formal criteria and/or syntax parsing as shown at block 114. The plurality of chunks and the corresponding plurality of sub-chunks are then displayed in a multidimensional format, including as a matrix. The plurality of chunks may be separated vertically with the plurality of sub-chunks divided in horizontal and depth dimensions. The plurality of chunk groups, chunks and the corresponding plurality of sub-chunks may then be re-sequenced, and if necessary restructured to match the likely target text structure and sequence. This version of the source will usually be a duplicate, retaining the original sequence and structure for reference. In some embodiments, this re-sequencing and/or restructuring can be performed automatically, or by input automatically requested from a translator user as shown at block 116. The translator input may be given by means of touch screen, voice control, keyboard, heads-up display (HUD), touchpad, and/or mouse.

The source text segment is then translated to a target text using a variety of methods. According to a preferred embodiment, the target text is input into a structured, chunked target input area next to the re-sequenced source text. The plurality of chunks and the corresponding plurality of sub-chunks in the target area are then preferably filled with corresponding translated text from a translation memory database, machine translation-generated text, and translator input as shown at blocks 118 and 118a. The translated text from the translation memory database and machine translation-generated text is then reviewed by a translator user as shown at blocks 120 and 120a. The alignment of the plurality of chunk pairs and in some embodiments, the corresponding plurality of sub-chunk pairs are validated for further translation memory and machine translation usage as shown at blocks 122, 122a and 122b. Finally, the translation pairs, especially sub-chunks, may be dynamically categorized, and rules may be generated for further use in translation as shown at block 124.

Previous translation-memory based Translation Environments (TEnTs) have relied upon segmentation of text by formal criteria, i.e., punctuation (primarily periods, colons, semi-colons), and other formal markers (e.g., formatting marks such as paragraph markers, other document structure markers such as cells, and/or tables and source document tags). These correspond to textual units with guaranteed syntactic cohesion between source and target. They form discrete syntactic units which fit sequentially into the order of the text. The present system and method uses additional criteria for chunking besides formal criteria, namely translation memory text portion availability and source text repetition within a document, corpora or very large corpora. The resulting chunks enable more productive translation.

In a further preferred embodiment, chunk size is not absolute, and the invention provides translators with the option to configure one or more of the parameters used for dividing any given text into chunks, including a preferred number of words in a chunk. Determining optimal chunk boundaries is important in order to provide for chunking to provide the best outcomes for user(s) productivity. A number of criteria are employed to maximize the number of text groups likely to retain syntactic cohesion in the target text.

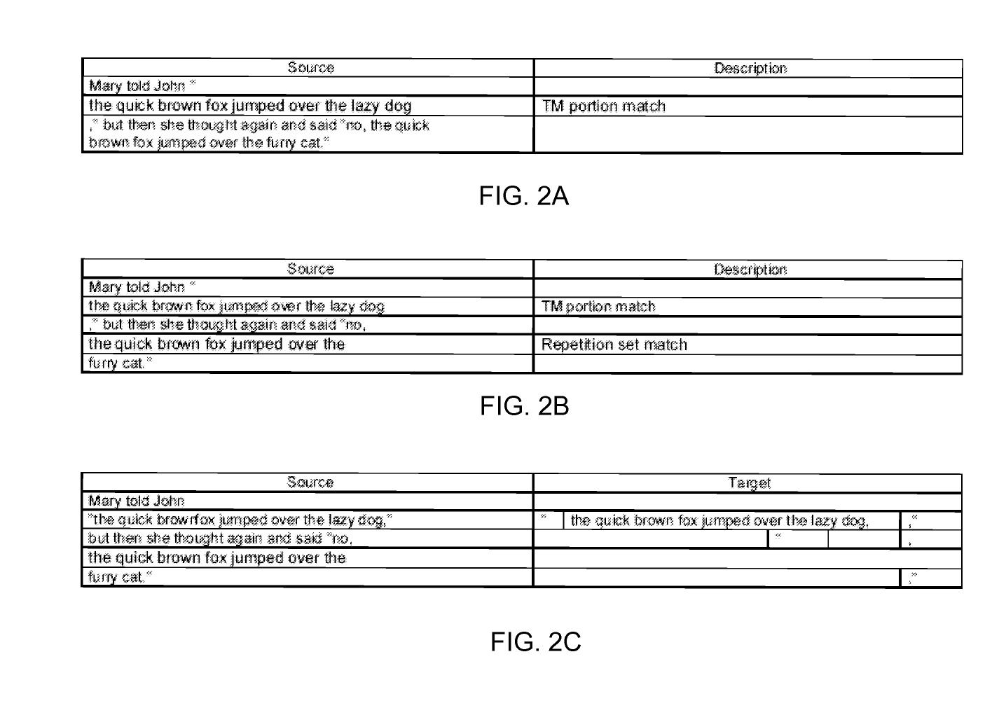

FIGS. 2A-2C illustrate an example of several criteria being employed to chunk a text segment. The figures show a text segment (Mary told John ‘the quick brown fox jumped over the lazy dog,’ but then she thought again and said ‘no, the quick brown fox jumped over the furry cat.’) being separated into chunks by applying three criteria namely, translation memory portion matches, repetition sets and punctuation.

The first criterion used for chunking is translation memory text portion availability as illustrated in FIG. 2A. Any available translation memory text portions from a translation memory database which match the text in a given segment are used. The remaining portions of the source text segment are then chunked after accounting for the translation memory text portion chunk(s). In some embodiments of the present invention, large translation memory text portions may be further subdivided into translation memory text portion chunks with the full translation memory portion being treated as a chunk group. Like other chunks, translation memory text portion chunks may also be subdivided into sub-chunks. Translation memory text portions may further provide for alignment between the source and target text. The system provides for not aligning the source text and target text if the target translation changes due to a shift in context or by translator user configuration. The number of available translation memory text portions preferably grows as more and more text portions are aligned.

After the chunks have been formed based on matches with translation memory text portions, or if there are no translation memory text portions available, the second criteria for chunking is applied which is source text repetition within a document, corpora or very large corpora as illustrated in FIG. 2B. The remaining portion of the source text is matched with word and/or token sets which repeat within a document, a corpora, a very large corpora, or any subset of these. Like with translation memory text portions, large repetitive word sets may be further subdivided into repetitive word set chunks, with the full repetitive word set being treated as a chunk group. The boundaries of repetitive sets can also be overlaid onto translation memory word portion matches, providing further leveraging by the system and users of the system. Like other chunks, repetitive word set chunks may also be subdivided into sub-chunks. The degree of utility of such division is determined both by the usefulness of the divisions as well as the interfaces used to manipulate the chunking elements. The repetition criteria may also be utilized within a repetitive word set to form repetitive chunks and sub-chunks. In an embodiment of the present system, repetition criteria are utilized for multi-nested word sets which are found as components of multiple repetitive word sets.

Word sets repeated within a document provide immediate leveraging to a translator user utilizing the present system and method, providing the translator with motivation to align the translation. The smaller the size of a repeated word group, the more likely it is that it will have ambivalent meanings which vary by context. The translator may find it useful to input various criteria for repetitions. Thus, the translator may select user configurable system options providing, for example, that all word sets containing four words or more must be repeated six times to be considered for chunking, while word sets of eight words or more need only be repeated twice.

In another non-limiting example of the present system and method, a translator user may interact with the present system to work with other translators together in a group. In this example, the users may configure the system to translate the most frequent repetitive word sets, and especially those with nested repetitive word sets in advance. In a preferred embodiment, the translator can compile a document which contains the repetitive chunks which contain within themselves the most frequent repetitive sub-chunks. In this way, it is possible to optimize the benefits of translating in context with the benefits of translating the most frequent repetitive word chunks in advance.

In an example wherein the translation memory text portions and large repetitive text database have not populated, there may be many large segments which have no translation memory text portions available and no repetitive text chunks. In this example, methods previously known to those of skill in this art may be used to chunk texts into groups which provide utility to human translators. The criteria are still different than those for machine translation, however. Since a human being understands grammar intuitively rather than formally, formal syntax parsing is not necessary. More utilitarian criteria, including simply the visual clues automatically provided by the present system such as by punctuation and the number of words in a chunk (approximating a human utterance) may often prove sufficient to divide text up into chunks and sub-chunks as illustrated in FIG. 2C.

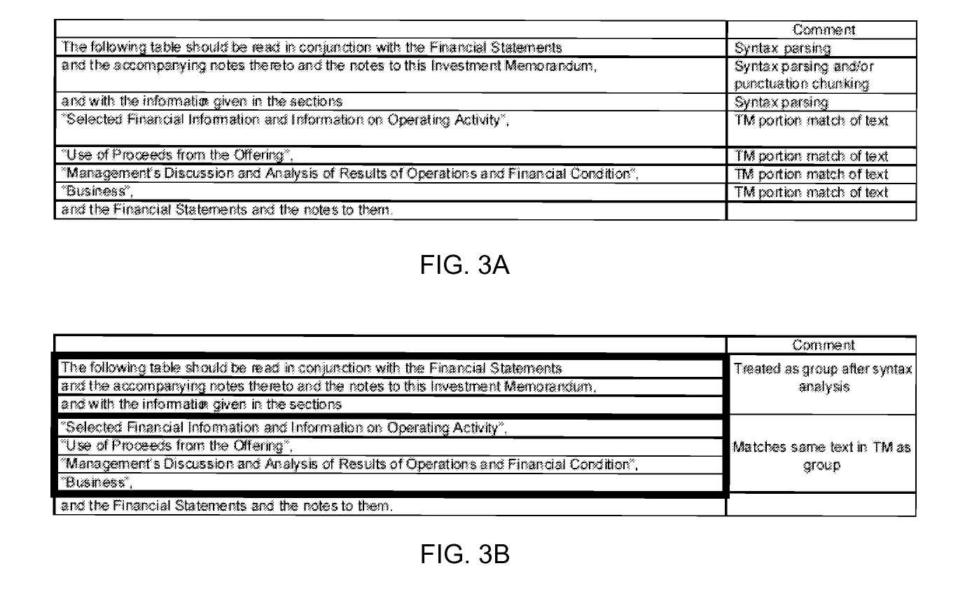

FIGS. 3A-3B illustrate an example of grouping of chunks in a text segment after applying chunking criteria. The FIG. 3A shows a text segment divided into chunks after applying syntax chunking criteria. Other embodiments of the invention may employ variable length criteria for displaying key elements in the syntactical hierarchy, such as verbs and conjunctions, which may have a minimum length of one word or zero (for things like implied verbs).

The FIG. 3B shows the chunks being automatically grouped into chunk groups. Chunks can be combined into chunk groups based groups based on several criteria. Chunk groups may be the result of translation memory text portion or repetitive word sets chunks which have been further divided into chunks. Chunk groups may also be the result of grammar analysis and the grouping together of chunks which form a grammatical group which is likely to have semantic cohesion between the source to extend the translation but which may be moved from one position in the source text to another position in the target text.

The plurality of chunks may be further divided into various levels of sub-chunks. While it will often be more efficient for a translator to input a chunk as a whole utterance, in other situations, it may be useful to have small text portions and repetitive chunks occupy a position within a chunk. Even within a chunk, the grouping of elements is important. Accordingly, there may be several variants as illustrated in Table 1 shown below. Sub-chunks may be grouped as units defined by the criteria used to form chunks (i.e., punctuation and syntax parsing). For example, “My friend has seen the beautiful mountain” may be divided into a number of levels of sub-chunks, each of which reveal themselves using a function for zooming and/or cycling of a multi-dimensional interface provided by the present system. Variants for the sub-chunking of this word and token set are illustrated in Table 1. The sub-chunking variants shown in the figures and table do not conflict with each other, and may be accessed directly, especially when using voice control commands. Conflicting sub-chunking variants may also be possible and still be usable when using an interface which allows for efficient cycling between the various sub-chunking schemes.

TABLE 1

| 1 | “My friend has seen the beautiful mountain” | | | | | | | | | |
|---|---|---|---|---|---|---|---|---|---|---|
| 2 | “ ” | | | | | | | | | |
| 3 | “ | My friend | | has seen | | the beautiful mountain | | | ” | Subject- |
| | | | | | | | | | | Verb |
| | | | | | | | | | | Object |
| 4 | “ | My | friend | has seen | | the | | mountain | ” | Discreet |
| | | | | | | beautiful | | | | semantic |
| | | | | | | | | | | units |
| 5 | “ | My | friend | has | seen | the | beau- | mountain | ” | Discreet |
| | | | | | | | tiful | | | tokens |

In the example shown, levels 1-2, 5 are based on formal criteria, while levels 3-4 rely upon syntactic parsing. Level 4 further relies upon language-pair specific rules (here English to a non-Western European language which lacks articles). A further example illustrated in Table 1, “the mountain” is the minimum discreet semantic unit to which the target translation will map.

Depending on various factors, including the degree of repetition within a document and the complexity of the source texts, translators may prefer to configure the system to display sub-chunks filled with translation memory text portion, machine translation (MT)-generated target text, or to leave chunks and sub-chunks blank to be filled through translator input. Even in the latter case, a sub-chunking structure in the target text which is based in the source text may greatly enhance an ability to align sub-chunk elements. In some cases, very short chunks may be effective, in particular when there is a small, semantically and syntactically, text element between two well-defined chunks, such as a conjunction, as illustrated in Table 2 shown below.

TABLE 2

| Source | Description |
|---|---|
| The quick brown fox jumped over the lazy | TM text portion |
| dog | |
| and | TM entry |
| raided the chicken house. | Repetitive word sets for |
| | manual or MTtranslation |

As an alternative, some translators may prefer display of such connector chunks as sub-chunks within more regularly-sized chunks. Repetitive but highly ambiguous sub-chunks may be added to a user-configured blacklist provided by the present system so that they are not filled in to a relevant sub-chunk. The translation variants will be available as reference selections, but not automatically filled in to a sub-chunk slot in the target translation.

In a preferred embodiment of the present system and method, a module for presenting text and inputting structure, which places the segment into a two-dimensional format (an orthogonal grid in one embodiment) may be provided. According to this aspect of the invention, the text input and manipulation structure is a multi-dimensional matrix (or other multi-dimensional structure) which allow different levels of chunking, chunk grouping and sub-chunking to be displayed using a drill-down/zoom-type function. In the example illustrated in Table 1, each of the five sub-chunking variants would represent a different level accessible through zooming/drilling down, including by direct voice command (e.g., “drill to discrete semantic”). Alternatively, some embodiments of the invention may make it possible for the translator to access certain types of chunking, leaving other types to be invoked using specific commands or excluding them altogether. The zooming function preferably makes it possible to provide for exhaustive sub-chunking without imposing any distracting level of detail when it is not needed. Sub-chunking detail can be provided according to user-programmable settings upon request or at a certain translation stage. For instance, it may be provided upon completion of the target chunk, the target segment, or during review of the translation.

In a multi-dimensional matrix embodiment of the present system, chunks are separated vertically with sub-chunks divided in the horizontal and depth dimensions. Such an arrangement greatly increases an ability to restructure sentences with minimal user input, especially through the use of complex touch screen commands and a large variety of voice control commands Using current standard input devices (e.g., keyboard and mouse), less rapid, but still functional access may be provided to sub-chunk selection and manipulation functionality through menu-driven commands and a hotkey command structure which uses multiple-key command codes (e.g., Alt+S for “select chunk”) to select and manipulate chunked elements.

According to a further aspect of the present invention, a translator user may interact with the system via touch or a touchscreen, allows user fingers to act alone or in combination with a variety of movements to execute various text selection and manipulation operations. Along with HUD, voice control and voice input, it can also offer relief from repetitive-motion injuries which are incurred over time by those who use mice and keyboards extensively. In a preferred embodiment, using voice recognition systems to input, edit, restructure and move chunked elements may provide advantages over keyboard entry.

In one embodiment of the present invention, the present system may further process target chunks to insert punctuation, codes, numbers and unambiguous small translation memory text portions (and optionally machine translation text), while providing a certain amount of space to insert words to be input by the translator. Further, chunked elements may be auto-propagated to sub-chunks in other segments unless such auto-propagation is disabled in general or for a specific chunking element.

The translation process is managed, and often carried out by the translator. The plurality of target chunk areas and the corresponding plurality of sub-chunks in the source text are filled in with corresponding translated text from translation memory database, machine translation-generated text, and through translator input. This may be modified further by making various levels of sub-chunks the current input or editing point. Movement of the insertion point can occur both automatically, especially as the system becomes better able to determine what text has already been translated, as well as through translator control. Paced, automated movement of the insertion point will greatly increase overall translation speed. Review of the translation memory database text and machine translation-generated texts may be conducted by the translator for quality control.

According to a further preferred aspect of the invention, the system may be configured to automatically move source chunks in certain situations. Specifically, the target chunks may be filled in or moved into place and the corresponding source text chunk elements may be selected and moved into place to align with them. Such selection is activated either through translator selection of a translation chunk slot (empty chunk) which corresponds to the source chunks, or through automatic system recognition of the alignment between the target text input and the source chunk. The system may preferably include two different types of displays: one which displays two versions of the chunked source text (one in original position) and another as restructured and re-sequenced. In this embodiment, the display preferably replicates the efficiencies of human mental re-arrangement while unburdening short-term human memory and providing a more transparent visual display for translators and reviewers to compare source text and translated text.

A further preferred feature of the present invention includes an element for displaying multiple instances of repetitive word sets throughout the text when they are being translated, especially for the first time, in order to ensure correct translation of the text in varying contexts. In some instances, it may be necessary to translate the same repetitive set in a number of different ways. Such multiple context use may arise automatically, especially upon translation of the first instance of the repetitive word set or upon request. Further, repetitive set chunks, chunk groups and their multi-nested chunk and sub-chunk elements may be automatically aligned and adjusted by translators if necessary. In a preferred embodiment, comprehensive alignment of all chunking elements in the target text, down to the most granular possible alignment level, is preferably achieved either via user configuration or by cycling through a series of alignment options provided by the system.

According to a further aspect, the present invention discloses optional collaborative organizational models to analyze and classify words and word pairings and the dynamic generation of rules “from the bottom up.” According to this feature, the system and methods include the steps of analyzing, categorizing and dynamically generating rules using input from large numbers of working translators, proceeding to more general categorizations and rules as possible, especially in order to automatically resolve conflicts among granular rules. One such example of automatic rule generation by the system is a rule for the recognition and translation of regular expressions (regex) through building an accessible graphic regex rule-builder. The text categorization and rule generation are preferably both immediately applicable for translation memory application as well as generate new models for machine translation processing of natural language.

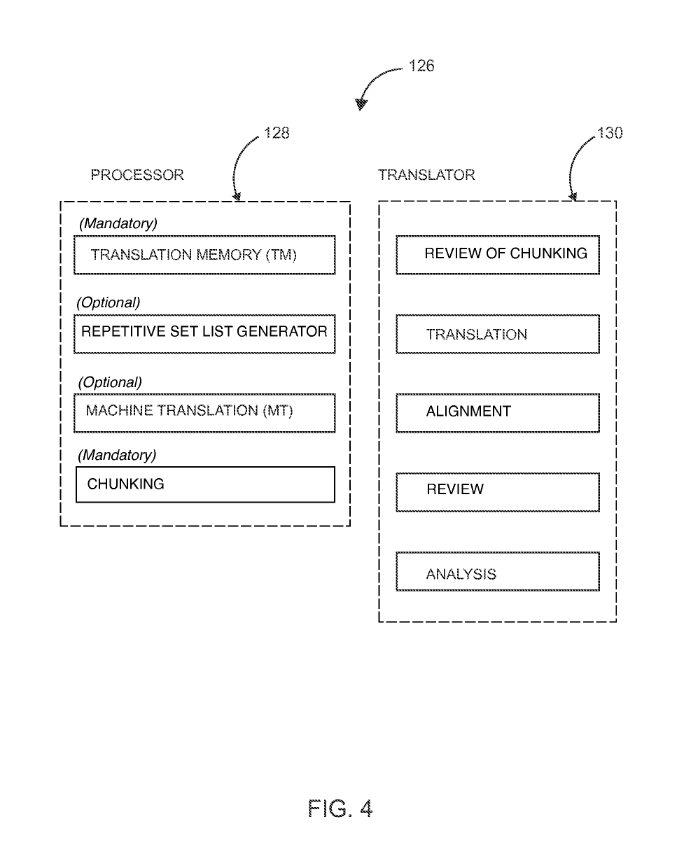

FIG. 4 illustrates a block diagram of a language translation system 126 in accordance with a further preferred embodiment of the present invention. As shown, the language translator system 126 of the present invention includes both a processor 128 and a translator 130. The present invention discloses a hybrid approach, whereby the processor 128 assists the translator 130 by dividing the text into chunks for further human processing. The translator 130 may or may not reconstruct the chunks formed by the processor 128. For manipulating the chunks, a multi-dimensional input structure is provided by the processor 128. The translation and consecutive alignment and review are done by the translator 130. The processor 128 preferably assists in translation by providing both translation memory (TM), repetitive sets from the source document, corpora or large corpora, and machine translation (MT). The system 126, especially when combined with the multi-dimensional text input and processing structure, makes it easier for the translator 130 to structure and sequence the mental processes required when producing and reviewing translations, including machine translations, alleviating the mental processing burden and substantially increasing translation productivity and quality.

Finally, the method and system 126 of the present invention can also be used to transcribe and structure speech so that the very mentally intensive work of interpreters can also be assisted through providing interpreters with the ability to structure rapidly transcribed speech for best translation results while decreasing the burden on their short-term memory.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method for assisting in the translation of a source text which is electronically stored in a computer, the method comprising:
adjusting a boundary of a tentative chunk boundary using formal markers;
determining whether a text portion in the source text matches a translation memory word portion,
designating a text portion which matches a translation word portion as a tentative chunk candidate boundary;
determining whether there is a match between a text portion and a stored repetitive set;
designating a text portion which matches a stored repetitive set as a tentative chunking boundary;
establishing an explicit chunk size limitation;
adjusting a boundary of a tentative chunk boundary using the established maximum chunk size;
creating additional chunks from remaining unchunked sections of the source text using formal markers and syntax parsing methods;
adjusting a boundary of the additional chunks using the established maximum chunk size;
displaying a re-sequenced version of source text chunks; and
generating a target text input space structured in accordance with one or more adjusted chunk boundaries of the source text and displaying translation word matches and repetitive text matches.

2. The method of claim 1, wherein the method further comprises the step of:
adjusting a boundary of a tentative chunk boundary using syntax parsing methods.

3. The method of claim 2, wherein the syntax parsing methods use the syntactic hierarchy of the source text.

4. The method of claim 3, wherein the method further comprises the step of:
re-sequencing identified chunks to match a likely target text structure and sequence;

5. The method of claim 4, wherein the target text input space displays the re-sequenced version of source text chunks, the translation word matches and the repetitive text matches using multiple dimensions.

6. The method of claim 5, wherein the explicit chunk size limitation is in the range of 4-16 words.

7. A computer program product, the computer program product comprising one or more computer readable storage media having encoded thereon computer executable instructions which, when executed upon by one or more computer processors, perform a method of assisting to translate a source text, the product comprising:
a first module for adjusting a boundary of a tentative chunk boundary using formal markers;
a second module for determining whether a text portion in the source text matches a translation memory word portion,
a third module for designating a text portion which matches a translation word portion as a tentative chunk candidate boundary;
a fourth module for determining whether there is a match between a text portion and a stored repetitive set;
a fifth module for designating a text portion which matches a stored repetitive set as a tentative chunking boundary;
a sixth module for establishing an explicit chunk size limitation;
a seventh module for adjusting a boundary of a tentative chunk boundary using the established maximum chunk size;
an eighth module for creating additional chunks from remaining unchunked sections of the source text using formal markers and syntax parsing methods;
a ninth module for adjusting a boundary of the additional chunks using the established maximum chunk size;
a tenth module for displaying a re-sequenced version of source text chunks; and
an eleventh module for generating a target text input space structured in accordance with one or more adjusted chunk boundaries of the source text and for displaying translation word matches and repetitive text matches.

8. The product of claim 7, wherein the product further comprises:
a twelfth module for adjusting a boundary of a tentative chunk boundary using syntax parsing methods.

9. The product of claim 8, wherein the syntax parsing methods of the twelfth module include using the syntactic hierarchy of the source text.

10. The product of claim 9, wherein the product further comprises:
a thirteenth module for re-sequencing identified chunks to match a likely target text structure and sequence;

11. The product of claim 10, wherein text input space of the eleventh module displays the re-sequenced version of source text chunks, the translation word matches and the repetitive text matches using multiple dimensions.

12. The product of claim 11, wherein the explicit chunk size limitation is in the range of 4-16 words.
